(19) United States
(12) Patent Application Publication
(10) Pub. No.: US 2026/0238950 A1
(43) Pub. Date: Aug. 13, 2026

(54) GENERATION OF PERSONALIZED HEAD-RELATED TRANSFER FUNCTIONS (PHRTFS)

(71) Applicant: DOLBY LABORATORIES LICENSING CORPORATION

(72) Inventors: Jeremy Grant Stoddard, Highfields (AU); Dirk Jeroen Breebaart, North Sydney (AU); David S. McGrath, Rose Bay (AU); Rhonda J. Wilson, San Francisco, CA (US); Andrea Fanelli, Seattle, WA (US); Hailong Shi, Beijing (CN)

(73) Assignee: DOLBY LABORATORIES LICENSING CORPORATION, (US)

(21) Appl. No.: 19/156,816

(22) PCT Filed: Feb. 14, 2024
(86) PCT No.: PCT/US2024/015701

§ 371 Date: Aug. 14, 2025

Related U.S. Application Data
(60) Provisional application No. 63/485,627, filed on Feb. 17, 2023.
(60) Provisional application No. 63/624,560, filed on Jan. 24, 2024.

(30) Foreign Application Priority Data
Feb. 16, 2023 (WO) PCT/CN2023/076573
Dec. 21, 2023 (WO) PCT/CN2023/140677

(51) Int. Cl. H04S 7/00; G06V 40/16

(52) U.S. Cl. CPC H04S 7/304; G06V 40/171; H04S 2420/01

(57) ABSTRACT

A method for generating personalized head-related transfer functions (pHRTFs) for a user of a media playback device comprising acquiring a feature set, x, including anthropometric features acquired with an image capturing system, estimating an initial parameter set, y′, including pHRTF model parameters for the user based on a statistical relationship between the pHRTF model parameters, y, and the feature set, x, estimating a set of final model parameters, y″, and generating a set of pHRTFs from the set of final model parameters. The set of final model parameters are based on the initial parameter set, y′, a demographic prior distribution describing expected variation of pHRTF model parameters, and an accuracy prior distribution describing expected errors in the initial parameter set, y. The accuracy prior distribution is derived from accuracy statistics associated with the image capture system.

### CROSS-REFERENCE TO RELATED APPLICATIONS

This application claims the priority benefit of U.S. Provisional Application No. 63/624,560 filed Jan. 24, 2024, International Application No. PCT/CN2023/140677 filed Dec. 21, 2023, U.S. Provisional Application No. 63/485,627 filed Feb. 17, 2023, and International Application No. PCT/CN2023/076573 filed Feb. 16, 2023, each of which is hereby incorporated by reference in their entireties.

### TECHNICAL FIELD OF THE INVENTION

The present invention relates to a generation of personalized head-related transfer functions (pHRTFs).

### BACKGROUND OF THE INVENTION

Head Related Transfer Functions (HRTFs) are a set of functions describing how human ears receive sound from sources at varying directions of arrival. The functions typically describe linear filtering processes that reflect the acoustic effect of the ears, head and torso on incoming sound waves.

Personalized HRTFs (pHRTFs) are HRTF sets that are tailored or adapted to a specific user's anatomical features. They can be obtained through experimental measurement procedures, or modelled using personalized information pertaining to the user.

One approach to generating pHRTFs from image capture data is described in US2021/0211825. This document describes the process of deriving landmarks and anthropometric features to generate pHRTFs.

### GENERAL DISCLOSURE OF THE INVENTION

It is an object of the present invention to provide an even further improved approach to the generation of pHRTFs.

According to a first aspect of the invention, this and other objects are achieved by a method for generating personalized head-related transfer functions (pHRTFs) for a user of a media playback device comprising acquiring a feature set, x, including anthropometric features based on anatomical attributes identified in images of the user acquired with an image capture system, estimating an initial parameter set, y′, including pHRTF model parameters for the user based on a statistical relationship between the pHRTF model parameters, y, and the feature set, x, estimating a set of final model parameters, y″, and generating a set of personalized head-related transfer functions from the set of final model parameters. The set of final model parameters are based on the initial parameter set, y′, a demographic prior distribution describing expected variation of pHRTF model parameters, the demographic prior distribution derived from sample data from a population, and an accuracy prior distribution describing expected errors in the initial parameter set, y, the accuracy prior distribution being derived from accuracy statistics associated with the image capture system.

This approach significantly facilitates generation of personalized HRTFs. By relatively simple statistical operations, highly relevant pHRTFs can be generated from a set of images acquired e.g. with a handheld device.

In some implementations, the method further comprises acquiring demographic data, D, of the user, and the estimated initial parameter set, y′, is based also on the demographic data, D, including e.g. one or more of birth sex, age, height, weight, ethnicity This may even further improve reliability and accuracy of the method, Further, in this case, the demographic prior distribution may be derived from sample data from a population having the same demographic data, D, as the user. This may even further improve accuracy.

In some implementations, the step of acquiring the feature set, x, includes scaling the anatomical attributes using an image scaling factor obtained from one or several image scaling factor estimates, such as a face detection algorithm, a deep learning strategy, a measurement of facial features in relation to known population averages of such features, and depth measurements. This approach may even further relax the requirements of the image acquiring process, making the method more robust.

### BRIEF DESCRIPTION OF THE DRAWINGS

The present invention will be described in more detail with reference to the appended drawings, showing currently preferred embodiments of the invention.

FIG. 1 shows a user with a set of headphones.

FIG. 2 is a schematic framework for generating pHRTF model parameters according to an embodiment of the invention.

FIG. 3 is a flow chart of a method for generating personalized head-related transfer functions (pHRTFs) according to an embodiment of the invention.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive. SSD. RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology. CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

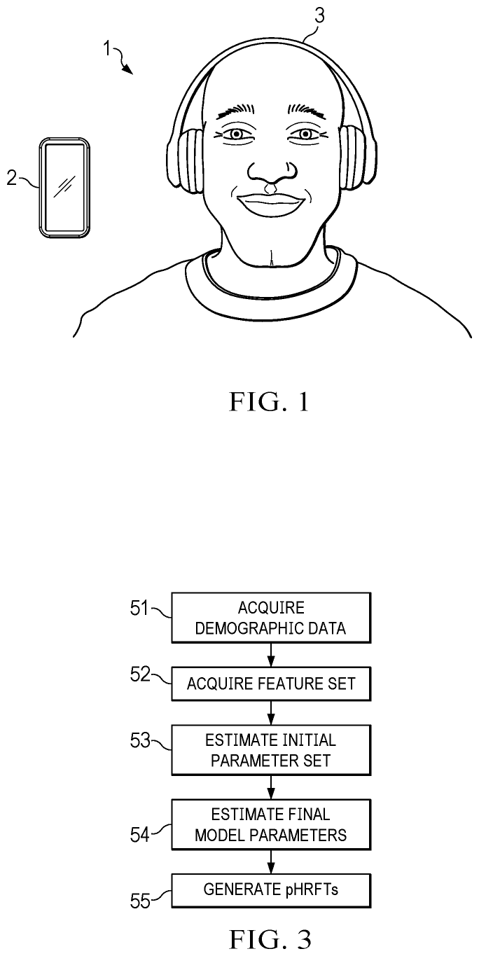

With reference to FIG. 1, a user 1 listens to audio played back from a media player 2, using a set of headphones 3. For binaural rendering of the audio, head related transfer functions are used. The present disclosure relates to generating personalized head related transfer functions (pHRTF).

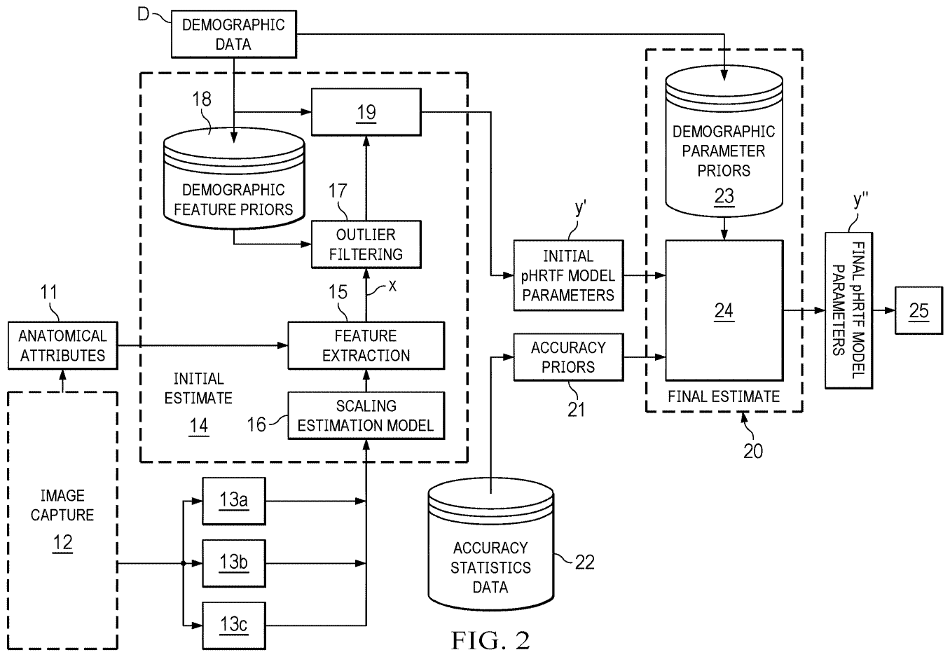

The framework 10 in FIG. 2 is configured to generate a set of pHRTF model parameters given a set of inputs.

In this example, a first input is a set of demographic data, D. of the user 1. The data D can include for example biological (birth) sex, ethnicity, height, weight and age. This data is assumed to be free of errors.

A second input is a set of anatomical attributes 11. The anatomical landmarks are obtained by means of an image capturing module 12, configured to capture a series of images of the user, in particular the head of the user. The image capture module 12 may be part of the media playback device 2 that the user 1 is using to playback audio content, and for which the personalized head related transfer functions are intended for. However, the image capture device 12 may alternatively be a separate device.

The image capturing module 12 is further configured to process the acquired images to identify the set of anatomical attributes 11. The attributes 11 may include landmarks, such as three-dimensional Euclidean coordinates of points of interest on the head, ears, and torso of the user. The attributes 11 may also include distances between such landmarks, or angles between such landmarks. In most cases, some or all of the anatomical attributes 11 have a specific amount of inaccuracy, or measurement/estimation noise.

In the illustrated example, where anatomical attributes 11 are obtained from an image capture process, a third input is one or several image scaling factor estimates 13a, 13b, 13c, which are also obtained from the image capture module 12. The image scaling factor estimates map the image coordinates of the anatomical attributes to a metric space in known distance units such as millimeters or meters. As examples, the estimated scaling factors 13a-c can be obtained from:
13a) Face detection algorithms, such as ARCore or Mediapipe, providing depth approximate values, including Deep Learning strategies leveraging human or environmental clues to generate an approximated depth map
13b) Measurement of facial features in the image plane, such as iris size, inter pupillary distance, or/and head size, and relating such measurements to a known population average
13c) Depth measurements, e.g. from a time-of-flight or LIDAR sensor, possibly integrated with the image capture module 13

The various inputs D. 11, 13a-c are provided to an initial estimation module 14. The module 14 includes a feature extraction unit 15, configured to extract a set x of anthropometric features from the anatomical attributes 11. The anthropometric features are typically scalar (one-dimensional). The specific features that are extracted will depend on the specific pHRTF model parameters of interest, and may be chosen as features which are strongly correlated with the model parameters of interest.

Where appropriate, the anthropometric features x are scaled to known units using a scaling factor determined by a scaling estimation model 16. The scaling estimation model 16 is applied to the various estimated scaling factors 13a-c, to determine a single “global” scaling factor to be applied in the feature extraction unit 15. The scaling estimation model 16 can be e.g., a weighted average, or a statistical model. In either case, the predictive power assigned to each scaling factor estimate should reflect its expected accuracy relative to the other metadata items.

Optionally, the anthropometric features x may be passed through an outlier filtering unit 17. In this unit, the extracted features are compared against a set of demographic feature prior distributions. These prior distributions describe the spread of each feature, and relationships between features, for a general population, or for a population that shares the same demographic data as the user. The demographic feature prior distributions may be selected from a database 18 using the user specific demographic data, D. If a feature in the set x deviates beyond a given degree from the expected spread, then the feature is excluded from the set.

One possible representation of these demographic prior distributions is using a multivariate normal distribution model, expressed as:

$$x ∼ 𝒩 ( {μ}_{x} , {\sum }_{x} ) ,$$

where [symbol] denotes a multivariate normal distribution, x is the vector of extracted features, μₓ is a vector of feature means in the distribution, and Σₓ is the feature covariance matrix in the distribution.

The prior distribution model is used to detect and handle significant feature outliers, which may be the result of a failure to accurately capture certain anatomical landmarks. The outliers can be detected by computing the statistical likelihood of each feature given the demographic-based prior distribution. When a feature has a likelihood that is below a specified threshold, it can be deemed an outlier, and either removed from the subsequent model estimation step, or reverted to its respective mean value in the prior distribution.

Further, the initial estimate module 14 includes a computation unit 19 configured to apply a known statistical relationship between anthropometric features, demographic data, and the pHRTF model parameters of interest. The computation unit 19 uses the statistical relationship to obtain a set, y′, of (estimated) initial pHRTF model parameters based on the anthropometric features x and demographic data, D.

In some implementations, the model 19 is a Bayesian model which relates the extracted features, the demographic data, and the model parameters of interest. Denoting the model parameters by a vector y, the feature vector as x, and the demographic data as D, a joint probability distribution function is considered:

$$p ( y , x \vert D )$$

This distribution can be obtained approximately using data for which there also exists ground truth values of y and x.

To estimate the initial pHRTF model parameters, y′, we can look at the posterior distribution,

$$p ( y \vert x , D ) ,$$

and in particular, the values of y which maximise this distribution yield an estimate known as the ‘maximum a posteriori’ or MAP estimate.

In the case that p(y, x|D) is a multivariate normal distribution,

$$p ( y , x \vert D ) ∼ 𝒩 ( [ \begin{matrix}{μ}_{Y} \vert D \\ {μ}_{X} \vert D\end{matrix} ] , [ \begin{matrix}{\sum }_{Y} \vert D & {\sum }_{Y X} \vert D \\ {\sum }_{X Y} \vert D & {\sum }_{X} \vert D\end{matrix} ] )$$

then the MAP estimate has a closed form solution:

$${y}_{MAP} = {μ}_{Y} \vert D + ( {\sum }_{Y X} \vert D ) {( {\sum }_{X} \vert D )}^{- 1} ( x - {μ}_{x} \vert D ) .$$

Apart from outlier filtering in unit 17, the initial estimate module 14 does not consider errors in the extracted anthropometric features x which may be incurred due to imperfections in the image capture module 12. Instead, these errors are compensated in a final estimation module 20.

This final stage considers two prior distributions:
1. The ‘accuracy prior’ 21—a distribution describing the expected errors in the initial set of model parameter estimates, y′. This distribution can be obtained approximately using accuracy statistics data 22 which, for a multitude of users, contains both actual (ground truth) model parameter values as well as noisy anatomical attributes resulting from a relevant image capture and processing stage.
2. The ‘demographic parameter prior’ 23—A prior distribution describing the expected behavior of actual pHRTF model parameters for a general population or for a population with the same demographic data, D, as the user.

A comparison of these two distributions can be used to compensate for errors introduced in the initial parameter estimates, y′, due to noisy measurement of anatomical attributes 11. In particular, as the expected errors in the pHRTF model parameters grow larger with respect to the spread of those same parameters in the demographic parameter prior 23, the final parameter estimates should be moved increasingly closer to their mean values in the demographic parameter prior.

For this purpose, the final estimation module 20 includes a compensation unit 24, which is configured to receive the initial model parameters y′, the accuracy prior 21 and the demographic prior 23, and output a set of final pHRTF model parameters y″.

One possible implementation of this error compensation, referred to as Bayesian regularization, would model each scalar parameter estimate, y′, as its ground truth value, y, with a zero-mean additive gaussian noise. i.e.

$${y}^{′} = y + e ,$$

$$e ∼ 𝒩 ( 0 , {σ}_{e}^{2} ) ,$$

where σₑ² is the variance of the error distribution. Then the final, error-compensated, model parameter, y″, can be computed as the MAP estimate from p(y|y′, D), given by

$${y}^{″} = {μ}_{V} \vert D + ( \frac{{σ}_{y}^{2} \vert D}{{σ}_{y}^{2} \vert D + {σ}_{e}^{2}} ) ( {y}^{′} - {μ}_{Y} \vert D ) ,$$

where μ_{y}|D and σ_{y}²|D are the parameter mean and variance from a normally distributed demographic parameter prior 23.

One inherent benefit of this approach is that if the image capture process or derivation of any information required to estimate or calculate model parameters fails, then the model can simply assume that the noise in the measurement error is infinitely high (σₑ²=∞) which will cause the method to use the demographic prior as the final model parameter:

$${y}^{″} {\vert}_{{σ}_{e}^{2} = ∞} = {μ}_{Y} \vert D$$

A processing unit 25 is connected to receive the final pHRTF model parameters y″ from the compensation unit 24, and configured to generate personalized HRTFs based on the final pHRTF model parameters y″.

Using the framework in FIG. 2, personalized head related transfer functions may be obtained by a method shown in FIG. 3.

First, in an optional step S1, a set of demographic features, D, are acquired. The demographic data D may be obtained directly from the user, by means of an appropriate user interface, possibly on the media playback device 2. Alternatively, the demographic data may be accessed from a database (not shown) containing such data for the specific user. Or, demographic data may be determined automatically by analyzing images of the user, e.g. the images acquired by the image capturing device 12 discussed above.

Then, in step S2, the image capture module 12 is used to acquire a feature set, x, including anthropometric features based on anatomical attributes identified in images of the user.

In step S3, an initial parameter set, y′, including pHRTF model parameters for the user is estimated based on a statistical relationship between the pHRTF model parameters, y, and the feature set, x, and, optionally, the demographic data D.

In step S4, a set of final model parameters, y″, are estimated based on the initial parameter set, y′, a demographic prior distribution describing expected variation of pHRTF model parameters, the demographic prior distribution derived from sample data from a population, and an accuracy prior distribution describing expected errors in the initial parameter set, y, the accuracy prior distribution being derived from accuracy statistics associated with the image capture module 11. The demographic prior distribution may be derived from sample data from a population having the same demographic data, D, as the user.

Finally, in step S5, a set of personalized head-related transfer functions is generated from the set of final model parameters, y″.

A specific example of how to generate pHRTFs based on model parameters is provided in co-pending application also titled, “GENERATION OF PERSONALIZED HEAD-RELATED TRANSFER FUNCTIONS (PHRTFS)”, (U.S. Provisional Patent Application No. 63/613,318; our reference number: D22130), incorporated herein by reference. In this case, the set of final model parameters includes five parameters: a per-ear frequency scaling factors, per-ear rotation angles, and a head radius. These model parameters are applied to a ‘template’ HRTF set to provide a personalized HRTF. Specifically, the frequency scaling factor may personalize frequency dependence, the per-ear rotation angles may rotate the HRTF coordinate system around the ear, while the head radius may apply frequency scaling at low frequencies and also manipulate the HRTF phase information.

In order to estimate the per-ear frequency scaling factor, the feature set may include a set of Euclidean distance measurements between pairs of anatomical landmarks. Similarly, in order to estimate per-ear rotation angles the feature set may include a set of median plane angles computed between anatomical landmark pairs. And finally, in order to estimate head radius, the feature set may include Euclidean distance measurements between paired left/right landmarks on either side of the user's head.

It should be noted that if the estimation of model parameters fails for one ear but is successful for the other ear of a user, an optional fallback for the system is to use the successfully estimated model parameters that were successfully acquired for a single ear to both ears. This provides satisfactory results given the typical high correlation between the model parameters for the left and right ear.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the preferred embodiments described above. On the contrary, many modifications and variations are possible within the scope of the appended claims. For example, the details of the statistical model may be modified, e.g. to account for additional statistical relationships which may be relevant to the pHRTF model parameters. Further, several other relevant model parameters, in addition to those mentioned herein may be envisaged by the skilled person. Also, additional processing modules may be added to the basic framework in FIG. 2, depending on the specific implementation.

1. A method for generating personalized head-related transfer functions (pHRTFs) for a user of a media playback device comprising:
acquiring a feature set, x, including anthropometric features based on anatomical attributes identified in images of the user acquired with an image capture system;
estimating an initial parameter set, y′, including pHRTF model parameters for the user based on a statistical relationship between the pHRTF model parameters, y, and the feature set, x;
estimating a set of final model parameters, y″, based on:
the initial parameter set, y′;
a demographic prior distribution describing expected variation of pHRTF model parameters, the demographic prior distribution derived from sample data from a population;
an accuracy prior distribution describing expected errors in the initial parameter set, y′, the accuracy prior distribution being derived from accuracy statistics associated with the image capture system; and
generating a set of personalized head-related transfer functions from the set of final model parameters.

2. The method of claim 1, further comprising acquiring demographic data, D, of the user, wherein the estimated initial parameter set, y′, is based also on the demographic data, D.

3. The method of claim 2, wherein the demographic prior distribution is derived from sample data from a population having the same demographic data, D, as the user.

4. The method of claim 1, wherein the step of acquiring the feature set, x, includes scaling the anatomical attributes using an image scaling factor obtained from one or several image scaling factor estimates.

5. The method of claim 4, wherein the image scaling factor estimates are obtained using at least one of: a face detection algorithm, a deep learning strategy, a measurement of facial features in relation to known population averages of such features, and depth measurements.

6. The method of claim 5, wherein the facial features include at least one of the user's irises, the user's inter-pupil distance, and the user's head size.

7. The method of claim 1, wherein at least one of the initial parameter set, y′, and the final parameter set, y″, is a maximum a posteriori, MAP, estimate.

8. (canceled)

9. The method of claim 1, further comprising removing outlier values from the feature set, x, using a demographic feature prior distribution describing expected variation of anthropometric features in a population.

10. (canceled)

11. The method of claim 1, wherein the demographic prior distribution is characterized by a probabilistic distribution function for one or more of the model parameters.

12. The method of claim 1, wherein the final model parameters include one or more of: a head size or radius, an ear size attribute or metric, and an ear orientation attribute or angle.

13. The method of claim 12, wherein the ear size attribute or metric, or ear orientation attribute or angle is determined separately for each of the user's ears.

14. (canceled)

15. A system for generating personalized head-related transfer functions (pHRTFs) for a user of a media playback device comprising:
an image capture module configured to acquire a set of images of the user, and identify anatomical attributes in the images;
a feature extraction unit configured to obtain a feature set, x, including anthropometric features based on the anatomical attributes;
a computation unit configured to estimate an initial parameter set, y′, including pHRTF model parameters for the user based on a statistical relationship between the pHRTF model parameters, y, and the feature set, x;
a compensation unit configured to estimate a set of final model parameters, y″, based on:
the initial parameter set, y′;
a demographic prior distribution describing expected variation of pHRTF model parameters, the demographic prior distribution derived from sample data from a population;
an accuracy prior distribution describing expected errors in the initial parameter set, y, the accuracy prior distribution being derived from accuracy statistics associated with the image capture system; and
a processing unit configured to generate a set of personalized head-related transfer functions from the set of final model parameters, y″.

16. The system of claim 15, wherein the computation unit is configured to receive demographic data, D, of the user, and wherein the estimated initial parameter set, y′, is based also on the demographic data, D.

17. The system of claim 16, wherein the demographic prior distribution is derived from sample data from a population having the same demographic data, D, as the user.

18. The system of claim 15, wherein the feature extraction unit is further configured to scale the anatomical attributes using an image scaling factor obtained from a scaling model based on one or several image scaling factor estimates.

19. The system of claim 18, wherein the image capture module is configured to obtain the image scaling factor estimates using at least one of: a face detection algorithm, a deep learning strategy, a measurement of facial features in relation to known population averages of such features, and depth measurements.

20. The system of claim 19, wherein the facial features include at least one of the user's irises, the user's inter-pupil distance, and the user's head size.

21. The system of claim 15, further comprising a filtering unit configured to remove outlier values from the feature set, x, using a demographic feature prior distribution describing expected variation of anthropometric features in a population.

22. The system of claim 15, wherein the demographic prior distribution is characterized by a probabilistic distribution function for one or more of the model parameters.

23. A non-transitory computer-readable storage medium storing executable instructions for:
acquiring a feature set, x, including anthropometric features based on anatomical attributes identified in images of a user acquired with an image capture system;
estimating an initial parameter set, y′, including pHRTF model parameters for the user based on a statistical relationship between the pHRTF model parameters, y, and the feature set, x;
estimating a set of final model parameters, y″, based on:
the initial parameter set, y′;
a demographic prior distribution describing expected variation of pHRTF model parameters, the demographic prior distribution derived from sample data from a population;
an accuracy prior distribution describing expected errors in the initial parameter set, v′, the accuracy prior distribution being derived from accuracy statistics associated with the image capture system; and
generating a set of personalized head-related transfer functions from the set of final model parameters.
